(19) United States
(12) Patent Application Publication
(10) Pub. No.: US 2009/0283044 A1
(43) Pub. Date: Nov. 19, 2009

(54) Telescopic bird feeder

(75) Inventor: Derek James Black, York (GB)

Correspondence Address: BROOKS KUSHMAN P.C., 1000 TOWN CENTER, TWENTY-SECOND FLOOR, SOUTHFIELD, MI, 48075, US

(73) Assignee: CRANSWICK PET AND AQUATICS PLC, Kingston Upon Hull (GB)

(21) Appl. No.: 12/122,046

(22) Filed: May 16, 2008

(51) Int. Cl. A01K 39/01

(52) U.S. Cl. 119/51.01

(57) ABSTRACT

A bird feeder comprising a bird food containment housing (1) which is closed at the bottom and open at the top to permit bird feed to be introduced, a closure member (2) for closing the open top of the housing (1), means (4) for releasably securing the closure member (2) to the housing (1), and a hanger (3) connected to the closure member (2) for suspending the bird feeder from a support, wherein the closure member (2) is connected to the housing (1) by a telescopic connection (4-8) which permits the housing (1) to be separated from the closure member (2) for filling.

### BACKGROUND OF THE INVENTION

1. Field of the Invention

The present invention relates to a bird feeder and more specifically to a tubular bird feeder.

2. Background Art

Tubular bird feeders are well known and generally comprise a cylindrical or otherwise tubular body which is closed at the bottom and which has a removable closure cap at the top through which the feed can be introduced into the tubular body. The tubular body may be made of an open mesh for large foods such as suet balls, peanuts and sunflower seeds or it may be comprised of transparent or translucent plastic with feed ports placed at intervals in the side thereof through which birds gain access for small foods such as millet seed, sunflower kernels and the like.

Tubular feeders are filled by removing the closure cap and pouring in bird feed through the open top. The problem with this design of feeder is that it must be removed from its hanger or support to remove the closure cap. The tubular body must be supported in the hand or on the ground as bird feed is poured in through the open top and this can make filling very difficult. At best there is a tendency to pour bird feed past the open top on to the ground. At worst the bird feeder may topple over during the filing operation.

### SUMMARY OF THE INVENTION

It is an object of the present invention to provide a bird feeder which can be filled with bird feed whilst the bird feeder remains suspended from its support or hanger.

According to the present invention there is provided a bird feeder comprising a bird food containment housing which is closed at the bottom and open at the top to permit bird feed to be introduced, a closure member for closing the open top of the housing means for releasably securing the closure member to the housing and a hanger connected to the closure member for suspending the bird feeder from a support, wherein the closure member is connected to the housing by a telescopic connection which permits the housing to be separated from the closure member for filling.

In a preferred embodiment of the present invention the telescopic connection comprises a first member connected to the inside of the closure cap and a second member connected to the bottom of the housing, and the first member is slidably received within the second member or visa versa. With the bird feeder suspended from a fixed support or hanger, the housing is pulled downwardly to cause the telescopic connection to open or extend. The housing is now suspended beneath the closure cap and bird feed can be poured in through the open top. Once the housing has been filled it is pushed back to cause the telescopic connection to close and to bring the housing back into closing engagement with the closure cap.

Various means may be envisaged for retaining the closure cap in the closed position. The inner and outer tubular members may be locked in the closed position by a screw threaded lock. By rotating the tubular body relative to the closure cap the screw threaded lock is unscrewed to allow the telescopic connection to extend.

In another embodiment of the present invention spring loaded latches are provided on one of the two sliding members of the telescopic connection which releasably engage in slots provided in the other of the two sliding members to secure the tubular member in the fully open position and in the fully closed position.

In yet another alternative embodiment of the present invention, the closure cap and the housing may be releasably secured together in the closed position by a bayonet type connection. In this arrangement the closure member is releasably secured to the tubular body by the engagement of a lock slot that communicates with a lock protrusion on the sidewall of the tubular body.

### BRIEF DESCRIPTION OF THE DRAWINGS

An embodiment of the present invention will now be described, by way of example, with reference to the accompanying drawings, in which:

FIG. 1 shows a schematic view of a tubular bird feeder according to a first embodiment of the present invention in the open position;

FIG. 2 shows a schematic view of the tubular bird feeder shown in FIG. 1 in the closed position;

FIG. 3 shows a schematic view of a tubular bird feeder according to a second embodiment of the present invention; and

FIG. 4 shows a schematic view of the tubular bird feeder shown in FIG. 2 in the closed position.

### DETAILED DESCRIPTION OF THE PREFERRED EMBODIMENT(S)

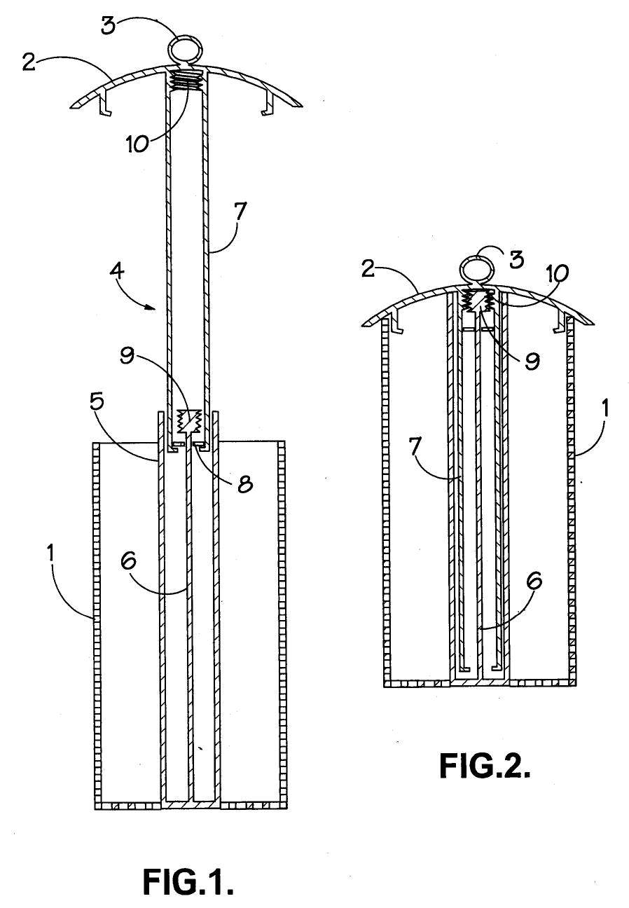

Referring to FIG. 1 the bird feeder comprises a cylindrical or otherwise tubular body 1 which defines a bird feed containment housing for retaining bird feed. The walls of the tubular body 1 may be formed of translucent or transparent plastics material with bird feeding ports situated at intervals therein for dispensing bird seed and small bird feeds, or may be of an open mesh for feeding peanuts, sunflower seeds, suet balls and the like. The bottom end of the tubular body 1 is closed, whilst the top end is provided with a removable closure cap or cover 2 to permit bird feed to be introduced therein. The closure 2 cap is provided with a hanger 3 for attachment to a hook or other hanging support member.

The tubular body 1 and the closure cap 2 are connected together by a telescopic connection 4 which allows the tubular body 1 to be dropped down and suspended beneath the closure cap 2 in the open position shown in FIG. 1. In this open position the tubular body 1 can very easily be filed with bird feed whilst the bird feeder remains suspended from its hanger. When the tubular body 1 has been filed with bird feed the tubular body 1 is lifted to close the telescopic connection 4 and to bring the tubular body 1 back into engagement with the closure cap 2. The tubular body 1 is then secured to the closure cap 2 as shown in FIG. 2.

The telescopic connection 4 connecting the tubular body 1 to the closure cap 2 may take a variety of forms and configurations. In the embodiment of the present invention shown in FIGS. 1 and 2 the telescopic connection 4 comprises a protective outer sleeve 5 to keep out bird food and an inner guide rod 6, both of which are attached at one end to the bottom of the tubular body 1, and an inner sleeve 7 which is attached at one end to the inside of the closure cap 2 and is slidably received over the guide rod 6 and within the protective outer sleeve 5 at the other end. The end of the inner sleeve 7 which is received within the protective outer sleeve 5 is closed apart from a small hole therein through which the guide rod 6 enters. At the upper end of the guide rod 6 there is provided a retainer or circlip 8 which retains the inner end of the guide rod 6 within the inner sleeve 7.

The upper end 9 of the inner sleeve 7 and the inner end 10 of the guide rod 6 are, respectively, internally and externally threaded. Rotation of the tubular body 1 relative to the closure cap 2 causes the externally threaded rod 10 to screw into or out of the internally threaded inner sleeve 9 to secure or release the closure cap 2 from the tubular body 1. However, as a perfectly acceptable alternative to this arrangement matching screw threads could be provided on the internal surface of the protective sleeve 5 and on the external surface of the inner sleeve 7. When these are screwed together the telescopic connection 4 is held together. In this arrangement the guide rod 6 could be dispensed with.

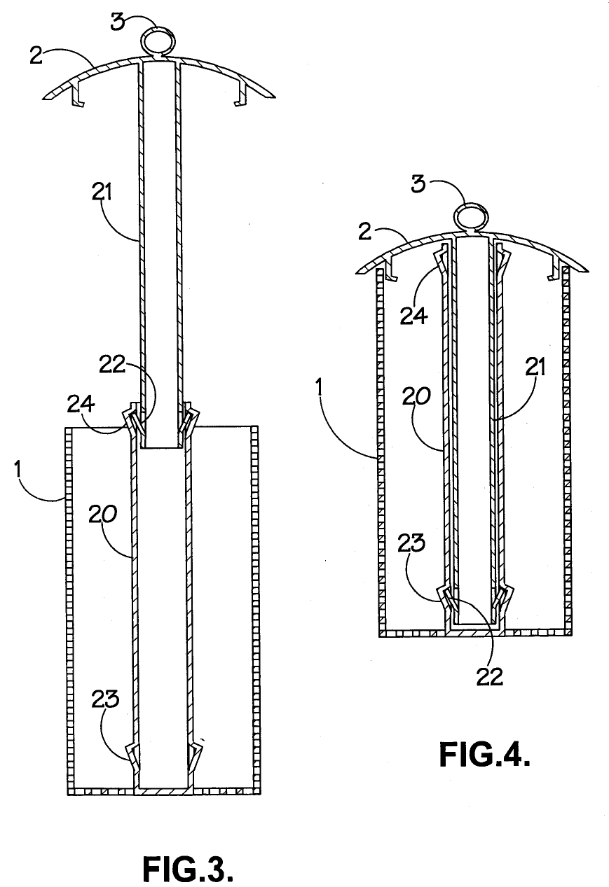

FIGS. 3 and 4 of the drawings show an alternative embodiment of the bird feeder according to the present invention in which the telescopic connection 4 which connects the tubular body 1 to the closure cap 2 takes the form of an outer sleeve 20 and an inner sleeve 21 which is slidable within the outer sleeve 20. A pair of spring loaded catches 22 are provided at the bottom end of the inner sleeve 21 and these are adapted to engage within slots 23 and 24 provided in the inner wall of the outer sleeve 20 at the top and bottom ends thereof.

With the bird feeder in the closed position shown in FIG. 4, the spring loaded catches 22 engage in the slots 23 to retain the tubular body 1 in a closed position relative to the closure cap 2. When it is required to open the bird feeder so that it can be filled with bird feed the spring loaded catches 22 are forced inwardly by a release mechanism (not shown for ease of reference) to release them from the slots 23. The tubular member 1 is now free to be pulled downwardly relative to the closure cap 2. As the outer sleeve 20 slides down over the inner sleeve 21 the spring loaded catches 22 remain pressed into the sides of the inner sleeve 21 by the inner wall of the outer sleeve 20 until the slots 24 are reached. At this point, the spring loaded catches 22 are free to spring outwardly to engage within the slots 24 and to retain the outer sleeve 20 on the end of the inner sleeve 21, as shown in FIG. 3.

When the tubular body 1 has been filed the bird feeder is closed by pushing the tubular body back up into engagement with the closure cap 2.

The bird feeder of the present invention allows the tubular body which contains the bird feed to be separated from the closure cap whilst the closure cap remains attached to its hanger or support. With the tubular body suspended at some distance beneath the closure cap there is nothing to prevent or impede bird feed from being poured in, and because the bird feeder always remains suspended from its hanger or support there is no danger of it falling over.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A bird feeder comprising:
a bird food containment housing which is closed at the bottom and open at the top to permit bird feed to be introduced;
a closure member for closing the open top of the housing; means for releasably securing the closure member to the housing; and
a hanger connected to the closure member for suspending the bird feeder from a support, wherein
the closure member is connected to the housing by a telescopic connection which permits the housing to be separated from the closure member for filling.

2. A bird feeder as claimed in claim 1, wherein the telescopic connection comprises a first member connected to the inside of the closure member and a second member connected to the bottom of the housing, the first member being slidably receivable within the second member, or vice versa.

3. A bird feeder as claimed in claim 2, wherein the first and/or the second member comprises a tube.

4. A bird feeder as claimed in claim 2, wherein the telescopic connection comprises a protective outer sleeve that is immovable, in use, relative to the intended bottom of the containment housing.

5. A bird feeder as claimed in claim 4, wherein the telescopic connection comprises an inner sleeve attached at one end to the inside of the closure cap and slidably receivable within the protective outer sleeve at the other end.

6. A bird feeder as claimed in claim 4, further comprising an inner guide rod immovable, in use, relative to the intended bottom of the containment housing.

7. A bird feeder as claimed in claim 6, wherein the telescopic connection comprises an inner sleeve slidably receivable over the guide rod and within the protective outer sleeve.

8. A bird feeder as claimed in claim 7, wherein the end of the inner sleeve which is received within the protective outer sleeve is closed apart from a hole therein through which the guide rod enters.

9. A bird feeder as claimed in claim 7, further comprising a retainer or circlip on the guide rod which retains the inner end of the guide rod within the inner sleeve.

10. A bird feeder as claimed in claim 1, further comprising a locking means for locking the telescopic connection in a retracted position in which the closure member closes the open top of the housing and/or an extended position in which the housing is separated from the closure member.

11. A bird feeder as claimed in claim 10, wherein the locking means comprises a screw-threaded lock.

12. A bird feeder as claimed in claim 11, wherein a portion of the external surface of the inner sleeve, and a portion of the internal surface of the protective sleeve are screw threaded.

13. A bird feeder as claimed in claim 11, wherein the upper end of the inner sleeve and the inner end of the guide rod are, respectively, internally and externally screw threaded.

14. A bird feeder as claimed in claim 10, wherein the locking means comprises one or more spring-loaded latches.

15. A bird feeder as claimed in claim 14, further comprising a release mechanism for releasing the latch or latches.

16. A bird feeder as claimed in claim 10, wherein the locking means comprises a bayonet type connection.

17. A bird feeder as claimed in claim 16, wherein one of the first or second members comprises lock slot and the sidewall of the other one of the first or second members comprises a lock protrusion.

18. A bird feeder as claimed in claim 1, wherein a wall of the tubular body is comprises one or more bird feeding ports.

19. A bird feeder as claimed in claim 1, wherein a wall of the containment housing comprises an open mesh portion.

20. A bird feeder as claimed in claim 1, further comprising a closure means for closing the intended lower end of the tubular body.
